(19) United States
(12) Patent Application Publication
(10) Pub. No.: US 2022/0354144 A1
(43) Pub. Date: Nov. 10, 2022

(54) CHEESE POWDER, METHODS FOR MANUFACTURING SAID CHEESE POWDER AND A CHEESE-BASED FOOD PRODUCT MADE FROM THE LATTER

(71) Applicants: Institut National de Recherche pour I'Agriculture, I'Alimentation et l'Environnement, Paris (FR); Institut National Supérieur des Sciences Agronomiques, Agroalimentaires, Horticoles et du Paysage, Rennes (FR)

(72) Inventors: Gilles GARRIC, Rennes (FR); Marielle HAREL-OGER, Gosne (FR); Thomas CROGUENNEC, Rennes (FR); Romain JEANTET, Rennes (FR); Anne THIERRY, Vezin Le Coquet (FR)

(21) Appl. No.: 17/622,407

(22) PCT Filed: Jun. 23, 2020
(86) PCT No.: PCT/EP2020/067526

§ 371 Date: Dec. 23, 2021

(30) Foreign Application Priority Data
Jun. 24, 2019 (FR) FR1906790

(51) Int. Cl. A23C 19/086; A23L 5/00; A23C 20/00

(52) U.S. Cl. CPC A23C 19/086; A23L 5/55; A23C 20/00; A23V 2002/00

(57) ABSTRACT

Disclosed is a cheese powder, methods for manufacturing the cheese powder, and a cheese-based food product made therefrom. The method includes: providing an aromatic matrix resulting from culturing a flavoring microorganism in a culture medium, and a texture matrix, at least some of the proteins of which consist of coagulating proteins which have not been subjected to prior coagulation; optionally mixing the aromatic matrix and the texture matrix to obtain a matrix mixture; and drying the matrices or the mixture of matrices to obtain a powder consistency, when the matrices or the mixture of matrices has a consistency ranging from liquid to paste. The obtained cheese powder has the following features: a total dry extract greater than or equal to 95% m/m, a water activity (aw) having a value of 0.1 to 0.25, and the coagulating proteins derived from the texture matrix have not been subjected to prior coagulation.

### CROSS-REFERENCE RELATED TO APPLICATION

This application is the U.S. national phase of International Application No. PCT/EP2020/067526 filed Jun. 23, 2020 which designated the U.S. and claims priority to FR Patent Application No. 1906790 filed Jun. 24, 2019, the entire contents of each of which are hereby incorporated by reference.

### BACKGROUND OF THE INVENTION

### Field of the Invention

The present invention relates to the technical field of cheese-based food products, in particular of the cheese, cheese speciality or cheese substitute type.

The present invention more particularly relates to a cheese powder and a method for manufacturing this cheese powder. It further relates to a method for the manufacturing of a cheese-based food product from this cheese powder.

### Description of the Related Art

In the food industry field, it is frequent to use microorganisms for the biotransformation of a raw material in such a way as to manufacture particular organoleptic characteristics and to obtain a finished product that corresponds to consumer demand.

This biotransformation is in particular implemented for the manufacturing of cheese-based food products, i.e. advantageously cheeses, cheese specialities or cheese substitutes.

Cheeses (soft cheeses to hard pressed cheeses) are conventionally obtained by transforming the milk into a gel or coagulum, thanks to the adding of a coagulating enzyme (rennet or equivalent) and via lactic acidification (under the action of lactic bacteria).

The interstitial liquid of the gel, i.e. the whey, is progressively expelled via syneresis (also known as “draining”).

During this syneresis, the gel is concentrated little by little in these main elements (fat and proteins, with a certain quantity of mineral substances), to result in a curd that acquires the characteristic shape, consistency and composition of the desired cheese.

In the case of ripened cheeses, a microflora comprised of various microorganisms then develops in the curd, and contributes in particular to producing the aromas sought: this is ripening.

This ripening phase is generally essential to provide its organoleptic qualities (aromatic and textural) to the final product.

In practice, this ripening phase is carried out over a long period of time (often several weeks, even several months), and require large storage areas designed to maintain temperature and hygrometry conditions that are conducive to the proper unfolding of the ripening.

Furthermore, in an industrial environment, this conventional approach has a certain number of disadvantages from the moment when it is suitable to control the step of refining in order to regularise and standardise the quality of the products, but also to reduce the duration thereof so as to control the cost thereof.

Alternative methods for manufacturing cheese-based food products have been developed in order to overcome these disadvantages.

Some of these alternative methods of manufacturing are based on the use of cheese powders that are intended for being rehydrated and textured to obtain the cheese-based food product desired.

This approach has in particular the interest of allowing for a decoupling between, on the one hand, the manufacturing of cheese powders on a first site and, on the other hand, the manufacturing of cheese-based food products on a second site, optionally separated in time and space.

But these alternative methods are not satisfactory as is.

Indeed, most known cheese powders require a step of refining in order to obtain finished products that have acceptable aromas.

Other cheese powders require the prior manufacturing of a cheese that will then be refined, then systematically leading to substantial manufacturing times.

In this context, there is a need for a cheese powder (including the method of manufacturing thereof) adapted to obtain a cheese-based food product of which the taste and the texture would be obtained immediately at the end of the manufacturing and can be elaborated as desired in a complete range, this without requiring prior or final ripening.

### SUMMARY OF THE INVENTION

The present invention thus relates to a cheese powder that is intended for being rehydrated and textured for the manufacturing of a cheese-based food product, for example of the cheese, cheese speciality or cheese substitute type.

More particularly, the invention aims to reorganise the major phases of cheese-making technology, in order to optimise them according to a definition of the functionalities of the finished product.

The present invention consists in particular of outsourcing the production of aromas, by optimising the triptych:
flavouring microorganisms (better producers of aromas and aromatic balancing),
adapted culture medium (milk, cream, plant juices, etc.), and
optimum development conditions (temperature, pH, time, oxygenation, stirring, etc.).

The method according to the invention further consists of decoupling the carrying out of the aromatic matrix and the carrying out of the texture matrix, then in assembling them in adapted proportions, before texturing the mixture of matrices in adapted physical-chemical conditions.

Finally, such a cheese powder can have different applications.

For major export, it is possible to manufacture the cheese powder according to the invention for end users who will only have to design tools to ensure the rehydrating, texturing and packaging, this without necessarily having cheese-making skills. The final product can be consumed as is, or have specific functionalities (stringy, brownable, meltable, sliceable, etc.).

A second use can be domestic: the cheese-based food product can be manufactured as desired according to the types of aromas produced and the quantity of water added, without specific equipment.

More particularly, according to the invention a method for manufacturing a cheese powder is proposed, said cheese powder being intended for being rehydrated and textured for the manufacturing of a cheese-based food product, advantageously of the cheese, cheese speciality or cheese substitute type.

The method for manufacturing comprises:

a) a step of providing:
at least one aromatic matrix resulting from a step of culturing at least one flavouring microorganism in a culture medium, said at least one aromatic matrix being intended for carrying out the flavouring of said cheese-based food product, and
at least one texture matrix, that is intended for carrying out the texture of said cheese-based food product, said at least one texture matrix comprises proteins (optionally without fat) of which at least some of said proteins consist of coagulating proteins that are able to coagulate to form a gel, said coagulating proteins have not been subjected to prior coagulation,

said at least one texture matrix preferably comprises proteins and fat of which the fat/protein ratio is advantageously from 0.1 to 6, preferably from 0.4 to 1.8, and

b) an optional step of mixing said at least one aromatic matrix and said at least one texture matrix, to obtain a mixture (advantageously homogeneous) of matrices, and

c) a step of drying at least one of said matrices (said at least one aromatic matrix and/or said at least one texture matrix) or of said mixture (advantageously homogeneous) of matrices to obtain a powder consistency, when at least one of said matrices or said mixture of matrices has a consistency ranging from liquid to paste,

And said cheese powder (separated matrices or mixture of matrices) has the following characteristics:
a total dry extract greater than or equal to 95% m/m,
a water activity a_{w} having a value of 0.1 to 0.25, even of 0.1 to 0.2, preferably of 0.15 to 0.2, advantageously (measured) at a temperature of 25° C.+/−1° C.,
said coagulating proteins derived from the at least one texture matrix have not been subjected to prior coagulation.

The present steps are advantageously implemented in such a way as to obtain said cheese powder selected from:
a combination of matrices comprising said at least one aromatic matrix and said at least one texture matrix, separated with respect to one another and each one in the form of powder, when said method of manufacturing is devoid of said step of mixing, or
said mixing of matrices, in the form of powder, when said method of manufacturing comprises said step of mixing.

According to a preferred embodiment, said step of providing consists of providing matrices that have, independently of one another, a consistency selected from:
a consistency of powder, or
a consistency ranging from liquid to paste, preferably, said at least one texture matrix having a consistency ranging from liquid to paste, comprising from 6% to 25% m/m of protein and from 0 to 30% m/m, even from 3% to 30% m/m, of fat, with where applicable a fat/protein ratio advantageously from 0.1 to 6, preferably from 0.4 to 1.8.

Moreover, the steps of the method of manufacturing are advantageously selected from one of the following combinations of steps:

according to a first combination (i):
said step of providing comprises the providing of said matrices each having the consistency of a powder, and
said step of mixing consists of mixing said powder matrices to obtain said mixture of matrices in the form of powder,

or

according to a second combination (ii):
said step of providing comprises the providing of at least one matrix having a consistency ranging from liquid to paste, then
said step of drying consists of drying said at least one matrix to obtain matrices each having the consistency of a powder, then
said step of mixing consists of mixing said powder matrices to obtain said mixture of matrices in the form of powder,

or

according to a third combination (iii):
said step of providing consists of providing at least one matrix having a consistency ranging from liquid to paste, then
said step of mixing consists in mixing said matrices to obtain a mixture of matrices having a consistency ranging from liquid to paste, then
said step of drying consists of drying said mixture of matrices to obtain said mixture of matrices in the form of powder,

or

according to a fourth combination (iv):
said step of providing consists of providing at least one matrix having a consistency ranging from liquid to paste, then
said steps of mixing and of drying said matrices are implemented simultaneously (co-drying), to obtain said mixture of matrices in the form of powder, with preferably said at least one aromatic matrix and said at least one texture matrix which are simultaneously incorporated during the drying by atomisation.

Other non-limiting and advantageous characteristics of the method in accordance with the invention, taken individually or according to any technically permissible combination, are as follows:
in the case of matrices having a consistency ranging from liquid to paste, said step of mixing comprises a step of homogenisation;
in the case of a mixture of matrices having a consistency ranging from liquid to paste, said step of drying said mixture of matrices consists of a step of atomisation;
the texture matrix consists of a retentate resulting from a filtration technique of a dairy product and/or of a plant juice; in this case, the texture matrix advantageously consists of a liquid pre-cheese, consisting of a retentate of the filtration of a milk wherein are retained in particular the proteins of the milk with optionally the fat and a portion of the minerals of the milk;
during the step of mixing, the aromatic matrix is comprised between 0.5 and 50% by weight, preferably 0.5 to 10% by weight, of the total mixture, limits included;
the step of providing consists of a method for the production of said aromatic matrix, comprising said step of culturing said at least one flavouring microorganism in said culture medium, and/or a method for the production of said texture matrix, in physical-chemical conditions intended for preventing the formation of gel;
for the manufacturing of a cheese of the ripened type, the flavouring microorganisms include ripening microorganisms during the method of production of the aromatic matrix;
the culture medium consists of milk or a product obtained from milk selected from concentrated milk or retentate, cream, cheese-making wheys, filtration permeates, or a plant juice;
the step of culturing is implemented over a period from 1 to 6, preferably from 1 to 4 days;
said at least one flavouring microorganism is alive in said cheese powder.

The present invention further relates to the cheese powder, advantageously resulting from the method for manufacturing according to the invention, said cheese powder is selected from:
a combination of matrices comprising said at least one aromatic matrix and said at least one texture matrix, separated with respect to one another, each one in the form of powder, or
said mixture of matrices, in the form of a powder,

said cheese powder has the following characteristics:
a total dry extract greater than or equal to 95% m/m,
a water activity a_{w} having a value of 0.1 to 0.25, even of 0.1 to 0.2, preferably of 0.15 to 0.2, advantageously at a temperature of 25° C.+/−1° C.,
said coagulating proteins derived from the at least one texture matrix have not been subjected to prior coagulation.

The present invention also relates to the method for the manufacturing of a cheese-based food product, advantageously of the cheese, cheese speciality or cheese substitute type.

The method in question comprises the following steps in succession:
a step of providing a cheese powder according to the invention, or resulting from a method for manufacturing according to the invention,
an optional step of mixing matrices of the combination of matrices in the form of powder,
a step of rehydrating the powder texture matrix (and optionally of the aromatisation matrix) or the mixture of powder matrices, in the presence of at least one Ca-sequestering salt and preferably of at least one acidity-regulating salt, to ensure the rehydration/solubilisation of said coagulating proteins and to obtain a cheese matrix that has a consistency ranging from liquid to paste,
where applicable, a step of mixing texture and aromatisation matrices, able to be rehydrated separately then mixed,
a step of texturing, during which said cheese matrix is subjected to physical-chemical conditions of texturing, always in the presence of at least one calcium (Ca) sequestering salt and preferably of an acidity-regulating salt, for the coagulation of said coagulating proteins and to form the gel, said physical-chemical texturing conditions are adapted according to the final texture sought for said cheese-based food product.

Other non-limiting and advantageous characteristics of the method in accordance with the invention, taken individually or according to any technically permissible combination, are as follows:
said step of rehydrating is carried out in the following conditions: a rehydration rate ranging from 40% H₂O to 80% H₂O, a temperature ranging from 30° C. to 80° C., preferably less than 60° C., even less than 50° C., a texturing time of 1 to 10 h, a dose of Ca-sequestering salt ranging from 2 to 50 g·kg⁻¹ of powder (m/m), and a dose of acidity-regulating salt ranging from 0 to 50 g·kg⁻¹ of powder (m/m);
during the step of texturing, the physical-chemical texturing conditions are selected from the temperature, the pH, the dose of NaCl, the dose of Ca-sequestering salt and the dose of acidity-regulating salt; in this case, preferably, the step of texturing is adjusted with the following physical-chemical texturing conditions: a pH comprised between 4.5 and 6.5, a temperature comprised between 10° C. and 60° C. for 1 to 10 h, a concentration in NaCl comprised between 0.1 and 2% m/m, a dose of Ca-sequestering salt from 2 to 50 g·kg⁻¹ of powder (m/m), optional, and a dose of acidity-regulating salt from 0 to 50 g·kg⁻¹ of powder (m/m), optional;
the method can comprise, following the step of texturing, a step of applying at least one surface ripening microorganism or a step of applying a coating layer, for example a coating wax;
during the step of texturing, said at least one flavouring microorganism is alive.

The present invention further relates to the cheese-based food product, advantageously of the cheese, cheese speciality or cheese substitute type, resulting from a method for manufacturing according to the invention.

Of course, the different characteristics, alternatives and embodiments of the invention can be combined with one another according to various combinations in that they are not incompatible or exclusive of one another.

### BRIEF DESCRIPTION OF THE DRAWINGS

In addition, diverse other characteristics of the invention shall appear in the accompanying description given in reference to the drawings that show the forms, which are not limiting, for carrying out the invention and where:

FIG. 1 is a block diagram showing the main steps of a method according to the invention for the manufacturing of the cheese powder according to the invention;

FIG. 2 is a block diagram showing the main steps for the manufacturing of the aromatic matrix;

FIG. 3 is a block diagram showing the main steps for the manufacturing of the cheese-based food product from the cheese powder according to the invention.

### DESCRIPTION OF THE PREFERRED EMBODIMENTS

Note that, in these figures, the structural and/or functional elements that are common to the different alternatives can have the same references.

Generally, the present invention relates to a new cheese powder and the method for the manufacturing of this cheese powder. This invention also relates to the method for the manufacturing of a cheese-based food product from cheese powder.

The method developed proposes a new cheese-making concept for dehydrated products, based on the decoupling and the optimising of the major steps in the manufacture of cheese.

This method makes it possible to independently generate the texture matrix and the aromatic matrix of the dehydrated finished cheese product, advantageously by assembly under a dry process or under a liquid process of the diverse texture and aromatic matrices created.

In practice, the drying can be done on each matrix separately, or on the assembly (or the mixing) of said at least two matrices.

According to the characteristics of the powder and its rate of rehydration, it is possible to create a diversity of textures ranging from that of a spreadable cheese to that of a hard cheese. It is also possible, according to the type of microorganisms implemented and the aromatic molecules produced, to generate varied aromatic profiles imitating all cheeses.

The aromatic profiles can be more original according to the associations of microorganisms used to produce for example sweet/salty, fruity, umami, cheese, etc. tastes or aromas

Likewise, it is possible to add diverse markers or inclusions and to propose varied forms, presentations, coverings, etc.

Again according to the invention, the method of manufacturing the food product has the interest of making it possible to obtain aromas and the texture of the final product immediately at the end of this method.

The cheese-based food product according to the invention, advantageously comprising aromas of ripened cheese, can thus be consumed immediately after the manufacture thereof (less than 12 h), without requiring the maintaining thereof for a lapse of time at a temperature and in conditions required for the biochemical and physical changes characteristic of the flavouring microorganisms to take place.

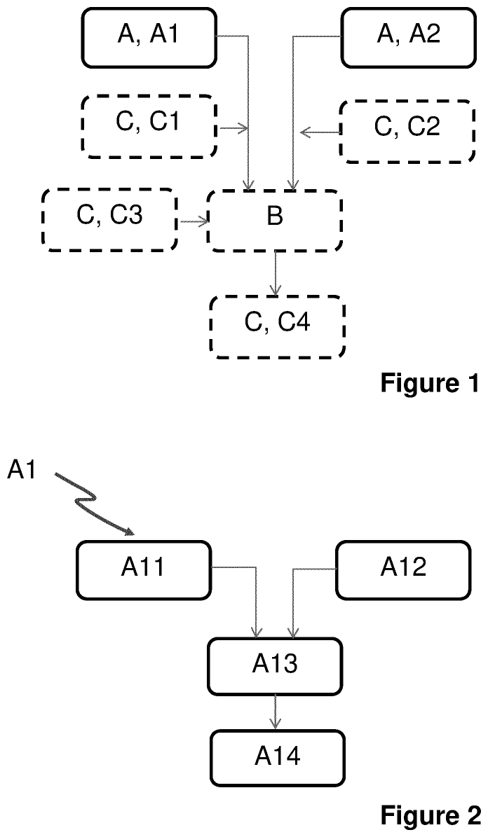

For this, such as schematically shown in FIG. 1, the cheese powder according to the invention advantageously is the result of the method for manufacturing comprising the following steps:

A) a step of providing a combination of at least two matrices:

A1) at least one aromatic matrix resulting from a step of culturing at least one flavouring microorganism in a culture medium, said at least one aromatic matrix being intended for carrying out the flavouring of said cheese-based food product, and

A2) at least one texture matrix, that is intended for carrying out the texture of said cheese-based food product,

then

B) an optional step of mixing said at least one aromatic matrix and said at least one texture matrix, in order to obtain a mixture of matrices,

and

C) an optional step of drying selected from a step of dryingC1 of said at least one aromatic matrix and/or a step of drying C2 of said at least one texture matrix and/or a step of drying C3 of said mixture of matrices, when at least one of said matrices or said mixture of matrices has a consistency ranging from liquid to paste.

The aforementioned steps A, B and C are implemented to obtain a cheese powder selected from:
a combination of matrices comprising said at least one aromatic matrix and said at least one texture matrix, separated with respect to one another and each one in the form of powder, or
a mixture of matrices, in the form of powder.

This cheese powder further has the following characteristics:
a total dry extract greater than or equal to 95% m/m,
a water activity a_{w} having a value of 0.1 to 0.25, even of 0.1 to 0.2, preferably of 0.15 to 0.2, advantageously at a temperature of 25° C.+/−1° C., and
said coagulating proteins derived from the at least one texture matrix have not been subjected to prior coagulation.

### General Definitions

In the framework of the present invention, “cheese-based food product” is advantageously a substance or a transformed product, intended for being ingested by human beings, that consists of a cheese strictly speaking or that is intended for replacing such a cheese.

Such a cheese-based food product advantageously encompasses food products of the cheese, cheese speciality or cheese substitute type.

A “cheese” is a product that is fermented or not, ripened or not, obtained from materials of exclusively dairy origin, coagulated entirely or partially before draining or after partial elimination of the aqueous portion.

A “dairy speciality” is a dairy product other than cheeses, curd cheese and blue cheeses, fermented or not, ripened or not, prepared from materials of exclusively dairy origin, to which other materials resulting exclusively from milk can be added, used alone or in a mixture.

A “cheese substitute” is a food product intended for replacing the cheese, mainly manufactured from plant raw material (cereal juice, legumes, etc. for example of the soya juice, oat juice, almond juice, etc. type).

Such cheese substitutes are also called “vegan cheeses”, “plant-based cheeses” or “analogue cheeses”.

In an individual, the consumption of such cheese-based food product will lead to a perception of a flavour.

The “flavour” corresponds to all the olfactory, gustatory and trigeminal sensations perceived during the tasting of a food.

These sensations allow for the perception of different orosensory stimuli:
tastes, also called “sapid stimuli” (in particular combined with the gustatory sensation),
aromas, also called “olfactory stimuli” or “odorous stimuli” (in particular combined with the olfactory sensation), and/or
trigeminal compounds (in particular combined with the somesthesic sensation and more precisely trigeminal perception).

In the present invention and with a concern for simplification, the notion of “aromas” will be used equivalently to the notion of flavour, thus encompassing the notion of aroma strictly speaking but also the notions of taste and trigeminal compounds.

“Taste” means in particular a stimulus perceived by taste receptors located on the tongue.

The perception dynamics of the taste is in particular governed by the temporal release of non-volatile compounds that dissolve in the saliva.

“Taste” in particular means the basic tastes: sweet, salty, sour, bitter and umami. It also includes the sensation of fat.

“Aroma” means the perception linked to the release dynamics of odorous volatile molecules in the orosensory sphere.

Such olfactory stimuli generally consist of volatile molecules that must be released from the product in order to reach the olfactory receptors located in the nasal cavity.

When the compound of interest is in the mouth, this perception is carried out in particular through retronasal olfaction.

Moreover, “texture” or “consistency” means a set of rheological properties and structure (geometrical and of surface) of the cheese-based food product, perceptible through the mechanoreceptors, the tactile receptors and, optionally, visual and auditory receptors of the consumer.

In the present invention, the consistency of the cheese-based food product is advantageously of the cheese inside type.

This notion of cheese inside advantageously encompasses a panel of the following consistencies: hard cheese, semi-hard cheese, semi-soft cheese, soft cheese, spreadable cheese.

The different notions in cheese-making technologies, including consistency, are described in the following documents:
FAO/WHO standard A-6—Cheese (1978, modified in 1990);
Technical specification B3-07-09 applicable to milks and dairy products (date of publication: November 2009) (Department of legal affairs—France);
Decrees 2007-628 of 27 Apr. 2007 and 2013-1010 of 12 Nov. 2013, pertaining to cheeses and cheese specialities (Ministry of the economy and finance—France).

Generally, according to the invention, all of the ranges indicated include the limits.

Furthermore, the concentration expressed in “% m/m” corresponds to a mass concentration (mass of the compound in relation to the total mass of the product).

“Total dry matter” of a product designates all of the non-volatile constituent elements thereof after desiccation via evaporation.

“Water activity” means the water vapour pressure of a wet product divided by the pressure of the saturation vapour pressure at the same temperature.

The main principles and requirements for the methods for determining the water activity (a_{w}) of food products for human consumption, and of food for animals, are conventional as such and are known to those skilled in the art.

The value of the water activity is thus comprised within a range of measurements ranging from 0 to 1.

The present invention, applied to food products for human consumption, advantageously involves a measurement of the water activity at a temperature of 25° C.+/−1° C.

Such a temperature is in any case implicit in the field of food products for human consumption, and of food for animals.

“Measurement at a temperature of 25° C.+/−1° C.”, this in particular means a water activity measured on a sample maintained at such a temperature of 25° C.+/−1° C. (advantageously in a micro-enclosure of the device for measuring said water activity, for example a resistive, capacitive or mirror a_{w}-meter).

The measuring principles are advantageously based on the measuring of the dew point or the determining of the variation in the electrical conductivity of an electrolyte or of the permittivity of a polymer.

Those skilled in the art can refer for example to International Standard ISO 187872017 or to French Standard ISO 18787.

The measurement of the water activity is advantageously implemented by means of an apparatus for measuring the water activity.

Such a measuring apparatus advantageously has the following characteristics:
a linearity response on the calibration range;
a measuring cell adapted to the measuring principle described hereinabove (measuring of the dew point or determining the variation in the electrical conductivity of an electrolyte or of the permittivity of a polymer);
a system for regulating the temperature of the measuring cell or that can be installed in a thermostatic enclosure in such a way as to guarantee a temperature of 25° C.+/−1° C.;
advantageously an internal resolution of at least 0.000 1 unit a_{w};
advantageously a display of at least 0.001 unit a_{w};
advantageously a determining of the final measuring point by reaching a plateau defined at a maximum amplitude of 0.0003, either by three consecutive measurements, or by a stability for 1 min;
where applicable, a system that makes it possible to suppress the interferences due to the volatile compounds of the sample (for example, specific filters).

The equipment must advantageously operate in conditions defined by the instructions of the manufacturer.

On the Aromatic Matrix

The aromatic matrix (also called “aromatisation matrix”), constitutes a product/compound that is intended for providing the aromas of interest to the final product.

Such as developed in what follows, during the step of providing, this aromatic matrix can have different forms, advantageously selected from a consistency of powder or a consistency ranging from liquid to paste.

This aromatic matrix is advantageously obtained through a method of culturing at least one flavouring microorganism, in a culture medium, advantageously a milk culture medium (preferably for cheeses and cheese specialities) or a plant culture medium (preferably for cheese substitutes).

The flavouring microorganisms in question, also called “aromatic yeasts”, are selected from microorganisms able to produce aromas that are sought for the final cheese-based food product.

These aromas of interest consist advantageously of aromas encountered in the cheese, preferably further selected from the following compounds:
1-octen-3-ol (hint of mushroom),
2-phenylethanol and phenylacetaldehyde (floral hint),
many sulphur compounds with varied hints (garlic, cabbage, potato, etc.) such as 2,4-dithiapenthane, 2,4,5-trithiahexane and 3-methylthio-2,4-dithiapentane, methyl sulphide, dimethyl disulphide, 3-methylthiopropanal and methanethiol (produced in particular in cheeses such as Epoisse, Vacherin, Pont-l'Evêque, Limburger),
propionic acid and other volatile acids, with a straight or branched chain,
free fatty acids,
esters (fruity hints),
diacetyl and related compounds (butter hint),
and many other compounds (aldehydes, ketones, lactones, furanones, nitrogen compounds such as indole, pyrazines, etc.).

An inventory is for example available in the overview article of Curioni and Bosset, 2002 (Curioni, P. M. G., & Bosset, J. O. (2002). Key odorants in various cheese types as determined by gas chromatography-olfactometry. International Dairy Journal, 12,959-984).

Such aromas are thus obtained by the culture of flavouring microorganisms (or “microorganisms of aromatic interest”), which encompass bacteria, yeasts or moulds (see for example chapter 11. Secondary and Adjunct Cultures, by Frangoise Irlinger, Sandra Helinck, Jean Luc Jany, in the book Cheese, Chemistry, Physics & Microbiology, Fourth edition, publishers: Paul L. H. McSweeney, Patrick F. Fox, Paul D. Cotter and David W. Everett, Academic Press, 2017).

In the case of a culture medium (dairy or plant juice), the aromas are advantageously developed by the release end products of a proteolysis (amino acids) and/or of a lipolysis and/or of a transformation of sugars.

Such aromas are thus obtained by the culture of flavouring microorganisms (or “microorganisms of aromatic interest”), which encompass bacteria, yeasts or moulds.

These flavouring microorganisms advantageously comprise the ripening microorganisms (or “ripening flora” or “ripening ferments”).

Ripening microorganisms comprise moulds and/or yeasts and/or bacteria that usually develop in the inside of a cheese, even on the surface of cheeses with a flowered, washed or salted rind.

These ripening microorganisms comprise:
moulds, such as Penicillium camemberti or Penicillium roqueforti;
yeasts, belonging in particular to genera Saccharomyces, Candida (Candida utilis), Geotrichum (for example Geotrichum candidum) and Debaryomyces hansenii; and
bacteria, such as propionic bacteria (Propionibacterium), and other diverse bacteria (Lactobacillus, more preferably Lactobacillus rhamnosus, Lactobacillus paracasei, Lactobacillus fermentum); among the bacteria, mention can also be made of Staphylococcus xylosus, Brevibacterium linens or easei.

The flavouring microorganisms can further be selected for example from Hafnia alvei, Yarrowia lipolytica.

Such flavouring microorganisms can also be selected from the microorganisms proposed by the companies CHR HANSEN (for example in the DVS™ range), LABORATOIRES STANDA (for example in the PAL™ range) or DANISCO (for example in the CHOOZIT™ Cheese Cultures range).

The flavouring microorganisms implemented come from a species or from a combination of at least two species that belong to the same kingdom or to different kingdoms.

Each species of microorganisms comes, furthermore, from a single strain or from a combination of at least two strains.

More generally, the flavouring microorganisms can also be selected from any other microorganism that is able to produce aromas via biotransformation and that is encountered in the field of the food industry (Techniques de l'Ingénieur—f3501—“Fermented food: l'ingénierie”—Oct. 9, 2014—Alain BRANGER).

For example, the flavouring microorganisms can further consist of lactic acid and aroma-producing bacteria such as Lactococcus lactis ssp lactis and ssp cremoris or var diacetylactis, Streptococcus thermophilus, Leuconostoc mesenteroïdes.

More generally, “flavouring microorganism” thus encompasses microorganisms able to produce aromas that are sought for the final cheese-based food product.

Such flavouring microorganisms are further described in the document Cheese, 4th edition, Chemistry, Physics & Microbiology, Vol. 1.

Again in other terms, “flavouring microorganism” thus encompasses the two types of cultures that are used in the manufacture of the cheese: primary cultures and secondary cultures.

Primary cultures include lactic acid bacteria (LAB), “starter”, involved in the production of acid during the manufacture and the ripening of these cheese.

Secondary cultures comprise the microorganisms involved solely in the ripening of the cheese (for example production of gas, coloration or the development of typical tastes).

As for the dairy culture medium, it constitutes a substrate that is selected from milk and the derivatives thereof: concentrated milks or retentates, cream, cheese-making wheys or filtration permeates (ultrafiltration, microfiltration).

“Milk” advantageously means a milk coming from a ruminant, for example cow, goat, ewe or buffalo or other.

Milk can have different forms: whole milk, semi-skimmed milk, skimmed milk; milk can also have the form of raw milk or pasteurised milk, microfiltered fresh milk, sterilised milk, UHT sterilised milk.

Cream is a milk containing at least 30 g of fat (coming exclusively from the milk) for 100 g of total weight (m/m).

Cheese-making wheys consist of co-products in cheese making, from the manufacture of fresh, soft, pressed and cooked cheeses.

Filtration permeates consist of a co-product during the concentration of a milk on filtration membrane (ultrafiltration, microfiltration or nanofiltration).

The plant culture medium constitutes a substrate that is selected from plant juices, for example soya juice, rice juice, almond juice, etc.

In practice, such as shown in FIG. 2, the flavouring microorganisms A11 are incorporated into the culture medium A12 during a step of mixing A13, then allowing for the implementation of a step of culturing A14 in optimum physical-chemical conditions until the obtaining of the aromatic matrix of interest in a non-solid consistency.

The physical-chemical conditions of the step of culturing A14, in particular the temperature, the pH, the oxygenation and the stirring, are adapted in particular to obtain optimum production of aromas by the flavouring microorganisms.

The physical-chemical conditions in question are for example presented in the document Techniques de l'Ingénieur—f3501—“Fermented food: l'ingénierie”—Oct. 9, 2014—Alain BRANGER.

For example, on the step of culturing A14, the aromatic matrix can be carried out in a tank or in a fermenter, according to the aromatic typicity sought.

The duration of this step of culturing A14 is advantageously about 1 to 10 days, even from 1 to 6, preferably from 1 to 4 days.

In the dairy culture medium, additional substrates can also be added, according to the microorganisms implemented.

The aromatic matrix thus obtained (resulting from the step of culturing A14) has a non-solid consistency, for example liquid, semi-liquid, semi-paste or paste.

Such as developed in what follows, this aromatic matrix can further be subjected afterwards to a step of drying in order to obtain an aromatic matrix having a consistency of powder.

Generally, this aromatic matrix contains a concentrate of the aromas sought (or more generally the flavours), that are produced by the flavouring microorganisms through the biotransformation of the culture medium.

Moreover, this “isolated” aromatic matrix can further be subjected to a phase of homogenisation such as described hereinafter in relation with the step of mixing.

This prior treatment improves the retention of the aromatic molecules provided by the aromatic matrix in the mixture of matrices.

On the Texture Matrix

The texture matrix is selected from the raw materials adapted for carrying out the final texture of the cheese-based food product.

Such as developed in what follows, during the step of providing, this texture matrix can have different forms, advantageously selected from a consistency of powder or a consistency ranging from liquid to paste.

The components of this texture matrix can come from a raw material or an assembly/mixture of at least two raw materials.

Said at least one texture matrix can comprise proteins and be devoid of fat (advantageously a low-fat powder).

Alternatively, said at least one texture matrix comprises proteins and fat.

The fat/protein mass ratio (also referred to as butyral level/protein level) is advantageously from 0.1 to 6, preferably from 0.4 to 1.8.

In the framework of a matrix that has a consistency ranging from liquid to paste, this texture matrix advantageously comprises proteins and fat with:
between 5% and 25% m/m of proteins, preferably 9% and 25% m/m of proteins, and
between 0% and 30% m/m, preferably between 3% and 30% m/m, of fat.

Among the proteins of this texture matrix, at least some consist of so-called “coagulable” or “coagulating” proteins, i.e. which are able to form a gel (protein gel) or “coagulum” during a coagulation process.

The gelling of the proteins is advantageously obtained from soluble proteins, of the whey protein or plant protein type.

In certain cases, acidification is necessary to obtain a better texture.

The adding of salts or ions can increase the gelling speed or the firmness of the gel obtained. The coagulating proteins are advantageously selected from proteins that can gel without heating or at least without significant heating (less than 50° C.):
either by adding ions (calcium or calcium phosphate),
or by alkalinisation followed by a return to neutrality or to the pHi of the protein (soya protein).

Alternatively, coagulating proteins can further be selected from proteins capable of gelling with a moderate heating, preferably less than 50° C.

In the present texture matrix, the proteins are in a “native” form, i.e. they have not been subjected to prior coagulation (without a prior step of texturing).

This texture matrix is then not subjected to a prior step of destructuring a coagulum, in order to allow for the intimate mixing thereof with the aromatisation matrix.

Such a texture matrix is advantageously selected from products with a milk base (“milk” texture matrix), or plant juice base (“plant” texture matrix).

Before a step of drying, the texture matrix advantageously has a non-solid consistency, for example liquid, semi-liquid, semi-paste or paste.

“Product with a milk base” means in particular milk as is, but also cream, buttermilk, wheys or filtration permeates.

For example, the coagulating proteins are caseins, of which the native form consists of a form of casein micelles.

This milk-based product comprises proteins selected advantageously from:
casein only (or “pure casein”),
casein and serum proteins.

“Coagulating proteins not subjected to prior coagulation” thus means in particular caseins in the form of casein micelles.

This product with a milk base is advantageously standardised from a physical-chemical standpoint, in particular:
in fat: level (butyral level), condition (homogenised or not),
in protein: serum protein/casein ratio,
lactose content,
from a mineral standpoint: calcium and phosphorus content.

The starting raw material can also be the object of a microbiological standardisation:
through a heat treatment (time/temperature pair), and
a physical purification treatment, for example of the microfiltration type.

The starting raw material is advantageously concentrated by a filtration technique, to a desired concentration factor (Volume Reduction Factor—“VRF”) in such a way as to obtain an optimum texture (for example a VRF factor comprised between 2 and 7).

The filtration technique implemented is advantageously selected from the techniques of ultrafiltration, microfiltration, nanofiltration, combined or not with diafiltration.

The texture matrix thus obtained consists for example of a product commonly designated as “liquid pre-cheese”.

The method for obtaining this liquid pre-cheese, as well as its characteristics, are described for example in the documents:
Maubois et al. “Application of Membrane Ultrafiltration to Preparation of Various Types of Cheese”, Journal of Dairy Science, Vol. 58, no. 7, or
Goudédranche et al. “Utilization of the new mineral UF membranes for making semi-hard cheeses”, Desalination, 35 (1980) 243-258.

Such a liquid pre-cheese thus consists of a protein-enriched milk (casein and optionally soluble proteins), forming a filtration retentate that comprises a content in protein adapted to the desired cheese and that has the composition of a curd at the end of draining while still remaining liquid (without coagulation of its coagulating proteins).

The volume reduction factor of such a liquid pre-cheese is advantageously comprised between 4 and 7.

The filtration operation is for this carried out on a semi-permeable membrane the permeability of which is such that only the soluble elements of the milk (i.e. essentially the lactose, and the soluble mineral salts and nonprotein nitrogen substances) pass through said membrane (for example in ultrafiltration).

This step of filtering is for example developed in the document Pouliot—International Dairy Journal—18 (2008) 735-740.

For the purposes of information, the operation of filtering is implemented in the following conditions:
ultrafiltration of which the cut-off threshold varies between 2,000 and 150,000 Da and the pressure applied between 2 and 10×10⁵ Pa,
microfiltration of which the cut-off threshold is greater than 150,000 Da and the pressure applied between 0.2 and 1×10⁵ Pa,
nanofiltration of which the cut-off threshold varies between 200 and 1,000 Da and the pressure applied between 10 and 40×10⁵ Pa.

This operation, for example of ultrafiltration, thus makes it possible to obtain two liquids:
a first liquid passing through the membrane, called “filtrate” or “permeate”, forming a sort of “ideal” whey devoid of protein nitrogen substances; and
a second liquid retained by the membrane, forming the aforementioned retentate, forming the protein-enriched milk (casein and soluble proteins).

This liquid pre-cheese can optionally be adjusted in fat, in particular by adding cream or Anhydrous Milkfat (AMF) for example.

Moreover, “product with a plant juice base” means in particular the juices of soja, oat, almond, pea, lupin, oat, rice, etc.

The product with a plant juice base can consist of a mixture of at least two of these juices, preferably a soya juice with at least one other juice.

For example, the texture matrix comprises a mixture:
soya juice with oat juice, of which advantageously the percentage by weight of oat juice is comprised between 5 and 10%, and
soya juice with lupin juice, of which advantageously the percentage by weight of lupin juice is comprised between 35% and 45%.

Such as developed hereinabove, the starting raw material is advantageously concentrated by a filtration technique, to a concentration factor sought in such a way as to obtain an optimum texture (for example a VRF ranging from 2 to 7).

The filtration technique implemented is advantageously selected from the techniques of ultrafiltration, microfiltration, nanofiltration, combined or not with diafiltration.

Such a plant juice thus consists of a plant juice enriched with proteins and calcium, forming a filtration retentate that comprises a content in protein adapted to the cheese substitute desired.

The volume reduction factor of such a plant juice is advantageously comprised between 4 and 7.

The filtration operation is for this carried out on a semi-permeable membrane the permeability of which is such that only the soluble elements of the juice pass through said membrane.

The plant juice can also be obtained from a flour suspended in a liquid (with for example a ratio of about ⅕) for an adapted period of time (for example 10 to 30 min), which is then filtered in order to obtain a concentrated plant juice forming the product with a plane juice base.

The starting product can also consist of a milk-based product combined with a plant juice.

In this case, the ratio varies for example between 10% and 90% for a first constituent, with respect to the second constituent.

Generally, the texture matrix thus obtained has a non-solid consistency, for example liquid, semi-liquid, semi-paste or paste.

Such as developed in what follows, this texture matrix can further be subjected to a step of drying to obtain a texture matrix that has a consistency of powder.

On the Step of Providing

The step of providing A consists of providing the aforementioned matrices for the implementing of the method of manufacturing the cheese powder.

The matrices provided have, independently of one another, a consistency selected from:
a consistency of powder, or
a consistency ranging from liquid to paste.

“Powder” means in particular a solid substance that is divided into very small particles.

In this case, the operator uses an aromatic matrix and/or a texture matrix that has the consistency of a powder.

This matrix was then advantageously subjected to a prior step of drying, in order to obtain such a matrix having a consistency of powder.

“Consistency ranging from liquid to paste” encompasses a non-solid consistency, for example liquid, semi-liquid, semi-paste or paste.

In this case, the operator uses an aromatic matrix and/or a texture matrix that has a consistency ranging from liquid to paste.

According to a preferred embodiment, at least the texture matrix has a consistency ranging from liquid to paste.

In this case, said at least one texture matrix advantageously comprises from 6% to 25% m/m of proteins and from 0% to 30% m/m, even from 3% to 30% m/m, of fat.

When said at least one texture matrix comprises proteins and fat, the fat/protein ratio is advantageously from 0.1 to 6, preferably from 0.4 to 1.8.

Again according to a particular embodiment, the present step of providing consists of:
the aforementioned method for the production of the aromatic matrix, comprising the step of culturing of said at least one flavouring microorganism in said culture medium, and/or
the aforementioned method for the production of the texture matrix, in physical-chemical conditions intended for preventing the formation of gel.

On the Optional Step of Mixing

Said at least one texture matrix and said at least one aromatic matrix can then be mixed together in proportions as desired, this in order to obtain a mixture of matrices (step B—FIG. 1).

Such a mixture of matrices, in the form of powder, has in particular the interest of being able to be rehydrated and textured directly, to obtain the cheese-based food product.

For example, said at least one aromatic matrix constitutes between 0.5 and 50% m/m, preferably between 0.5 and 10% m/m, of the mixture of matrices.

The time and the type of mixture have to be adapted to a perfect distribution (intimate) of the aromatic matrix in the texture matrix.

When at least one of the matrices has a non-solid consistency (liquid to paste), the step of mixing B can be done in scraped tank, in a scraped surface exchanger or in a static mixer.

Preferably, during this mixing, the matrices are maintained at a maximum temperature of 50° C.

Preferably, the mixture consists of a homogeneous mixture of matrices.

To this effect, so as to further perfect this non-solid mixture of matrices, the step of mixing comprises a step of homogenisation.

Homogenisation is a mechanical method to reduce the size of the particles in suspension in a medium.

In the method of the invention, any type of homogeniser can be used. In particular a high-pressure homogeniser will be used (for example a Rannie homogeniser, 2 heads, pressure of 0 to 400 bar, with 150 bar on the first head and 30 bar on the second head).

Those skilled in the art know the general characteristics of homogenisation installations, and, if needed, they can refer in particular to the document “Homogénéisation á haute pression des dispersions alimentaires liquides”, written by Sébastien Roustel, Technique de l'Ingénieur (2010) or “The high pressure dairy homogenizer”, L. W Phipps, Technical Bulletin, Ed NIRD (1985).

Generally, homogenisers can be divided into two categories:
“single-stage” homogenisers, including a single homogenisation head or valve, and
“double-stage” homogenisers, equipped with two homogenisation heads or valve, mounted in cascade.

For this second category of homogeniser, the medium containing the lipid droplets therefore passes through two heads or valves in succession, said heads or valves each having a very specific function translated by a different pressure.

In practice, the first stage, upstream, is the one in which is applied, in the head or the valve, a pressure having for effect to decrease the size of the lipid droplets.

The second stage, downstream, is the one in which the pressure applied in the head or the valve, advantageously corresponds between 10% and 20% of the pressure applied on the head or valve of said first stage. The function of this second stage is thus to break the aggregates or flocs that are formed in the medium after passing through the aforementioned first stage.

In order to prevent or at least limit the alterations linked to the thermal phenomena of heating, the homogenisation phase is more preferably implemented according to parameters (in particular temperature of the medium and homogenisation pressure) ensuring a maintaining of the temperature of the mixture of matrices within a range of values comprised between 50 and 70° C., more preferably about 60° C., all throughout said homogenisation phase.

The homogenisation phase advantageously verifies the following parameters:
a pressure of 100 bar to 500 bar, preferably from 100 to 300 bar, and
an inlet temperature of the mixture of matrices from 50 to 70° C., preferably about 60° C.

Alternatively, when the matrices have a consistency of powder, the step of mixing B can be done in a rotating stirred tank or with a mixing arm.

Generally, in this mixture of matrices, various additives can be incorporated, for example authorised products such as colouring agents or acidity regulators.

On the Optional Step of Drying

In this embodiment, said at least one aromatic matrix, said at least one texture matrix and/or said mixture of matrices can have a consistency ranging from liquid to paste.

A step of drying C is then implemented, before and/or after the optional step of mixing B, to obtain the final product having the consistency of a powder.

This step of drying C is advantageously adjusted in such a way that the powder obtained (single matrix or mixture of matrices) has the following characteristics:
a total dry extract greater than or equal to 95% m/m,
a water activity a_{w} having a value of 0.1 to 0.25, even of 0.1 to 0.2, preferably of 0.15 to 0.2, advantageously (measured) at a temperature of 25° C.+/−1° C.

For this, a single matrix or a mixture of matrices to be dried can be subjected to a step of drying C consisting of a step of atomising.

“Atomising” means in particular the method of dehydrating a liquid in the form of powder by passing in a flow of hot air.

During the dehydrating via atomising, the liquid is sprayed in fine droplets, in a vertical cylindrical enclosure (tower) in contact with a hot air current so as to evaporate the water. The powder obtained is driven by the flow of heat to a cyclone or a bag filter which will separate the air from the powder.

This step of atomising advantageously fulfils the following parameters:
a tower inlet temperature from 180 to 250° C.,
a tower outlet temperature from 50 to 100° C.

Alternatively, the aromatic matrix can be dehydrated via a freeze-drying technique.

More precisely, such as shown in FIG. 1, the step of drying C encompasses:
a step of drying C1, C2 implemented respectively on said at least one aromatic matrix and/or on said at least one texture matrix, prior to the step of mixing B of the matrices, to obtain at least one powder matrix, or
a step of drying C3, C4 applied on the mixture of matrices, either simultaneously to the step of mixing B of the matrices (co-drying) (step C3 in FIG. 1) or downstream from the step of mixing B of the matrices (step C4 in FIG. 1).

When the matrices are subjected to this step of drying C1, C2 before the step of mixing B, a combination of powder matrices is thus obtained, separated with respect to one another.

This combination of matrices then comprises at least one aromatic matrix and at least one texture matrix, each having the consistency of a powder.

These matrices in the form of powder are separated (independent) with respect to one another, for the purpose of a step of later mixing implemented before or after a step of rehydrating.

Before the steps of mixing and of rehydrating, this method of manufacturing thus makes it possible to obtain a cheese powder constituted of a combination of matrices separated with respect to one another.

The step of mixing B powder matrices, before a step of rehydrating, allows for the obtaining of a cheese powder constituted of the mixture of matrices.

Without being limiting, this step of drying C3, C4 applied on the mixture of matrices (advantageously resulting from a phase of homogenisation) has the interest of reducing the loss of aromatic molecules, or in other words of improving the retention of aromatic molecules provided by the aromatic matrix in the mixture of matrices.

Embodiments for the Method of Manufacturing the Cheese Powder

In practice, the aforementioned steps of this method of manufacturing are advantageously selected from one of the following combination of steps.

In a first combination (i):
the step of providing A comprises the providing of the matrices each having the consistency of a powder, then
the step of mixing B consists of mixing these powder matrices, to obtain the mixture of matrices in the form of a powder.

According to a second combination (ii):
the step of providing A comprises the providing of at least one matrix having a consistency ranging from liquid to paste, then
the step of drying C1, C2 consists of drying said at least one matrix to obtain matrices each having the consistency of a powder, then
the step of mixing B consists of mixing the powder matrices to obtain said mixture of matrices in the form of powder.

According to a third combination (iii):
the step of providing A consists of providing at least one matrix having a consistency ranging from liquid to paste, then
the step of mixing B consists of mixing said matrices in order to obtain a mixture of matrices having a consistency ranging from liquid to paste, then
the step of drying C̅4̅ consists of drying the mixture of matrices to obtain said mixture of matrices in the form of powder.

According to a fourth combination (iv):
the step of providing A consists of providing at least one matrix having a consistency ranging from liquid to paste, then
the steps of mixing and of drying matrices B, C3 are implemented simultaneously (co-drying), to obtain said mixture of matrices in the form of powder.

In this last combination, preferably, said at least one aromatic matrix and said at least one texture matrix are simultaneously incorporated during the drying via atomisation.

According to an alternative of the first combination (i) or of the second combination (ii), the method of manufacturing is devoid of the step of mixing B in such a way as to obtain the combination of matrices comprising said at least one aromatic matrix and said at least one texture matrix, separated with respect to one another, each one in the form of powder.

Cheese Powder

The present invention further relates to a particular cheese powder, intended for being rehydrated and textured for the manufacturing of a cheese-based food product, advantageously of the cheese, cheese speciality or cheese substitute type.

This cheese powder advantageously results from the method of manufacturing described hereinabove.

According to the invention, the cheese powder can have two forms, a function here of the steps of the method of manufacturing thereof.

According to a first form, the cheese powder comprises (even consists of) a combination of matrices (also called “kit” or “ready-to-use assembly”) comprising said at least one aromatic matrix (even at least two aromatic matrices) and said at least one texture matrix, separated with respect to one another and each one in the form of powder.

This first form is advantageously obtained in the case of a method of manufacturing devoid of the step of mixing B of the matrices.

Such an embodiment is interesting when an operator wants to use a “standard” texture matrix. The operator can then mix, as desired, this texture matrix with at least one aromatic matrix of their choice which is selected from a range of aromatic matrices.

According to a second form, the cheese powder comprises the mixture of matrices, in the form of powder.

This second form is obtained in the case of a method of manufacturing comprising the step of mixing matrices B.

Generally, the present cheese powder (according to the case, each power matrix or the mixture of matrices) has the following characteristics:
a total dry extract greater than or equal to 95% m/m,
a water activity a_{w} having a value of 0.1 to 0.25, even of 0.1 to 0.2, preferably of 0.15 to 0.2, advantageously at a temperature of 25° C.+/−1° C.,
said coagulating proteins derived from the at least one texture matrix have not been subjected to prior coagulation (for example caseins in the form of casein micelles).

Again generally, this cheese powder has the interest of being able to be produced on a first site, before being stored in a suitable packaging for a desired lapse of time (for example in a vacuum atmosphere or in a controlled atmosphere, thus limiting the caking of the powder).

This cheese powder can then be transported to a second site, at a distance, in such a way as to produce the cheese-based food product.

On the Step of Rehydrating

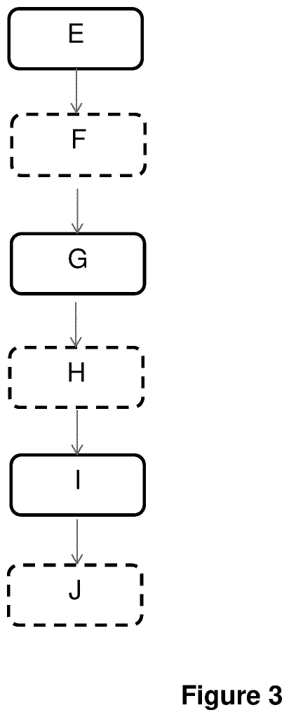

A food product can then be produced from the cheese powder according to the invention. The method in question is schematically shown in FIG. 3.

For this, the cheese powder according to the invention is first of all the object of a step of providing E.

Before rehydrating and in the case of a cheese powder in the form of a combination of matrices, a step of mixing F can be implemented in order to carry out the mixing of the powder matrices and to obtain the mixing of powder matrices (see step of mixing B in relation with FIG. 1).

Then, according to the case, the powder texture matrix (before mixing with the aromatic matrix) or the mixing of powder matrices is the object of a step of rehydrating G.

This step of rehydrating aims in particular to ensure the rehydrating/solubilising of the coagulating proteins resulting from the texture matrix, and to obtain a cheese matrix that has a consistency ranging from liquid to paste.

According to the invention, the step of rehydrating is advantageously carried out under stirring, in the presence of:
at least one calcium (Ca) sequestering salt, and preferably
at least one acidity-regulating salt.

Preferably, the step of rehydrating is carried out in the presence of a combination of said at least one calcium (Ca) sequestering salt and of said at least one acidity-regulating salt.

“Ca-sequestering salt” means in particular sodium citrate, potassium phosphate or polyphosphates.

“Acidity-regulating salt” means in particular citric acid or any other acid acceptable for use in food, glucono-delta-lactone (GDL).

In other terms, at least one calcium (Ca) sequestering salt and at least one acidity-regulating salt are added (mixed) to the powder texture matrix or to the mixture of powder matrices.

Without being limited by any theory, said at least one calcium (Ca) sequestering salt and said at least one acidity-regulating salt intervene in the solubilisation of the powder within the aqueous medium during the step of rehydrating and indirectly as a parameter that influences the texture/hardness sought.

According to a preferred embodiment, this step of rehydrating is carried out in the following conditions:
a rehydration rate ranging from 40% H₂O (m/m) to 80% H₂O (m/m), making it possible to obtain products in a TDM range ranging from 20 to 60% (m/m),
a temperature ranging from 30° C. to 80° C., preferably less than 60° C., even less than 50° C.,
a rehydrating time (even also texturing time) ranging from 1 to 10 h,
a dose of Ca-sequestering salt ranging from 2 to 50 g·kg⁻¹ of powder (m/m), preferably from 5 to 25 g·kg⁻¹ of powder, and preferably
a dose of acidity-regulating salt ranging from 0 to 50 g·kg⁻¹ of powder (m/m), even preferably from 1 to 50 g·kg⁻¹ of powder (m/m), further preferably from 2 to 50 g·kg⁻¹ of powder (m/m), further preferably from 5 to 10 g·kg⁻¹ of powder.

The doses of Ca-sequestering salt and of acidity-regulating salt are advantageously adjusted according to the texture/hardness sought:
for a soft cheese, a dose of Calcium sequestrant (Na Citrate) of 15 to 20 g·kg⁻¹ of powder (m/m), preferably from 17 to 18 g·kg⁻¹ (m/m) and a dose of an acidity regulator (citric acid) from 5 to 10 g·kg⁻¹ of powder (m/m), preferably from 7 to 8 g·kg⁻¹ (m/m),
for a hard cheese, a dose of Ca sequestrant (Na Citrate) of 20 to 25 g·kg⁻¹ of powder, preferably from 21 to 22 g·kg⁻¹ of powder (m/m), and a dose of an acidity regulator (citric acid) from 5 to 10 g·kg⁻¹ of powder (m/m), preferably from 7 to 8 g·kg⁻¹ of powder,
for a spreadable cheese, a dose of Calcium sequestrant (Na Citrate) of 15 to 20 g·kg⁻¹ of powder (m/m), preferably from 17 to 18 g·kg⁻¹ (m/m), and a dose of an acidity regulator (citric acid) from 0 to 10 g·kg⁻¹ of powder (m/m), preferably from 1 to 7 g·kg⁻¹ (m/m), even more preferably from 2 to 7 g·kg⁻¹ (m/m).

At the end of this step of rehydrating G and according to the starting product, two cases can be considered:
the mixture of matrices is rehydrated, forming a cheese matrix, or
the texture matrix is rehydrated, for the mixing thereof with the aforementioned aromatic matrix (possibly also rehydrated).

In this second case, the texture and aromatic matrices are now subjected to a step of mixing H, to obtain the cheese matrix. In practice, this step of mixing H is identical to the step of mixing B described hereinabove in relation with FIG. 1 for a non-solid texture matrix.

On the Step of Texturing

The cheese matrix obtained can then be the object of a step of texturing I that is adapted according to the final texture sought for the cheese-based food product.

This method according to the invention thus includes a step of texturing I only after mixing/rehydrating matrices.

This texturing consists of subjecting the cheese matrix to physical-chemical texturing conditions that are adapted to form the gel or “the coagulum” through the aforementioned coagulating proteins.

“Texturing” encompasses any mechanism that allows for the passage from the liquid state to the gel state.

Preferably, such a gel is advantageously constituted essentially of a gel of coagulating proteins (preferably casein) retaining the fat globules and a more or less substantial portion of the aqueous phase resulting from the matrices.

The coagulating proteins thus pass, for the first time, from a non-coagulated form to a coagulated form.

This texturing is here implemented always in the presence of said at least one Ca-sequestering salt and preferably of said acidity-regulating salt.

The physical-chemical texturing conditions, to which the cheese matrix is subjected, are in particular selected from:
the temperature,
the pH,
the concentration in salt, in particular the concentration in NaCl, and
possibly a dose of texturing agent (gelling and/or thickening),
the dose of Ca-sequestering salt, and
the dose of acidity-regulating salt.

The texturing agent is selected from compounds other than the rennet.

“Gelling” or “thickening”, also generally called “texturing agents”, mean in particular any substance that makes it possible to modify the consistency of a gel. These texturing agents can be of animal origin (gelatine), plant origin (plants, algae, etc.). This can be starch, pectin, carrageenans, alginates, gums for the main one among them.

For more details, each family of texturing agents can be distinguished in the collection “Additifs and adjuvants alimentaires” in the Techniques de l'ingénieur collections.

The regulating of these texturing parameters can be carried out by taking the following documents into account:
Maubois et al. “Application of Membrane Ultrafiltration to Preparation of Various Types of Cheese”, Journal of Dairy Science, Vol. 58, no. 7;
Goudédranche et al. “Utilization of the new mineral UF membranes for making semi-hard cheeses”, Desalination, 35 (1980) 243-258.

In particular, in the case of a “plant” texture matrix, a preferred mode of texturing would be via acidification, by means for example of glucono-delta-lactone (GDL) and/or ferments.

For example, and in a non-limiting manner, the doses of coagulants are from 2 to 5% calcium sulphate or from 3 to 10% calcium lactate or from 1 to 5% GDL.

In practice, for the different texture matrices, the following physical-chemical texturing conditions are advantageously implemented according to the texture sought:
a pH comprised between 4 and 6.5, preferably between 4.5 and 5.7,
a temperature comprised between 15° C. and 60° C. (preferably between 20° C. and 40° C.), for 1 to 10 h
a concentration in NaCl comprised between 0.1% and 2%, preferably comprised between 0.7% and 0.9%,
a dose of Ca-sequestering salt from 2 to 50 g·kg⁻¹ of powder (m/m), optional,
a dose of acidity-regulating salt from 0 to 50 g·kg⁻¹ of powder (m/m), optional, and optionally
a dose of texturing agent (gelling and/or thickening) comprises, on the one hand, between 0 and 0.6 kg. 100 kg⁻¹ (m/m), preferably comprised between 0.2 and 0.4 kg. 100 kg⁻¹ (m/m), of a gelling agent and, on the other hand, from 0 to 4 kg. 100 kg⁻¹ (m/m), preferably comprised between 1.5 and 2 kg. 100 kg⁻¹ (m/m) of a thickening agent.

The parameters hereinabove are in particular optimums in the case of a mixture of which the texture matrix was a liquid pre-cheese.

The adjusting of the pH can be obtained in various ways:
adding Glucono-Delta-Lactone (GDL),
adding milk or pre-acidified retentate,
adding acidifying ferments,
adding lactic acid.

This adjusting of the pH is advantageously carried out slowly and regularly, advantageously over a period of time comprised between 20 min and 30 min.

If necessary, the texturing agents can be incorporated into the texture matrix, before the mixing thereof with the aromatic matrix.

These texturing parameters are in addition advantageously adjusted in such a way that the flavouring microorganisms remain alive.

In particular, the physical-chemical texturing conditions can be adjusted in such a way as to allow for the obtaining of a cheese-based food product forming a cheese of which the texture can be adjusted as desired from a spreadable cheese to a hard cheese.

More precisely, these physical-chemical texturing conditions can be adjusted in order to obtain a cheese the inside of which includes one of the following textures/hardnesses:
a spreadable cheese,
a soft cheese,
a semi soft cheese,
a semi-hard cheese, and
a hard cheese.

In other terms, the hardness results are located within a range comprised between 3 kg·f⁻¹ and 40 kg·f⁻¹.

For example, the hardness is:
less than 10 kg·f⁻¹ for spreadable cheeses according to the type,
about 20 kg·f⁻¹ for soft cheeses, and
about 30 kg·f⁻¹ for hard cheeses.

A few physical-chemical texturing conditions are given as examples hereinbelow.

To obtain a cheese with a texture of the soft inside type:
a pH comprised between 4 and 6.5, preferably between 5.0 and 5.5,
a temperature comprised between 15° C. and 40° C., preferably between 20 and 35° C.,
a concentration in NaCl comprised between 0.1% and 2%, preferably comprised between 0.7% and 0.9%,
a concentration of calcium sequestrant (for example calcium citrate) from 15 to 20 g·kg⁻¹ (m/m) of powder,
a concentration of acidity corrector (for example citric acid) from 5 to 10 g·kg⁻¹ of powder,
optionally a dose of gelling agent comprised between 0 to 0.6 kg. 100 kg⁻¹ (m/m), preferably between 0.2 to 0.4 kg. 100 kg⁻¹ (m/m), and a dose of thickening agent from 0 to 4 kg. 100 kg⁻¹ (m/m), preferably comprised between 1.5 and 2 kg. 100 kg⁻¹ (m/m).

To obtain a hard cheese:
a pH comprised between 4 and 6.5, preferably between 5.2 and 5.7,
a temperature comprised between 15° C. and 40° C., preferably between 25 and 40° C.,
a concentration of calcium sequestrant (for example calcium citrate) from 20 to 25 g·kg⁻¹ (m/m) of powder,
a concentration of acidity corrector (for example citric acid) from 5 to 10 g·kg⁻¹ (m/m) of powder,
a concentration in NaCl comprised between 0.1% and 2% (m/m), preferably comprised between 0.7% and 0.9% (m/m),
optionally a dose of gelling agent comprised between 0 and 0.6 kg. 100 kg⁻¹ (m/m), preferably comprised between 0.3 and 0.4 kg. 100 kg⁻¹ (m/m), and a dose of thickening agent comprised between 0 and 4 kg. 100 kg⁻¹ (m/m), preferably comprised between 1.5 and 2 kg. 100 kg⁻¹ (m/m).

To obtain a spreadable cheese:
a pH comprised between 4 and 6.5, preferably between 4.8 and 5.2,
a temperature comprised between 15° C. and 40° C., preferably between 15 and 25° C.,
a concentration in NaCl comprised between 0.1% and 2% (m/m), preferably between 0.1% and 0.9% (m/m),
a dose pf Calcium sequestrant (Na Citrate for example) from 15 to 20 g·kg⁻¹ of powder (m/m),
a dose of acidity corrector (citric acid for example) from 0 to 10 g·kg⁻¹ of powder (m/m),
optionally a dose of gelling agent comprised between 0 and 0.6 kg. 100 kg⁻¹ (m/m), preferably between 0.15 and 0.20 kg. 100 kg⁻¹ (m/m) and a dose of thickening agent from 0 to 4 kg. 100 kg⁻¹ (m/m), preferably between 1 and 1.5 kg. 100 kg⁻¹ (m/m).

On an Optional Final Step

The step of manufacturing can include a final step J during which at least one surface maturing microorganism is applied.

Such a microorganism is for example selected from: Penicillium camemberti and/or Geotrichum candidum, even Brevibacterium linens.

The cheese-based food product is then stored for a sufficient time and in adapted conditions (in particular of temperature and hygrometry), in such a way as to obtain a development of the surface flora.

Preferably, this cheese-based food product can be left in a ripening room for the growth of surface microorganisms, this for four to five days and at a temperature comprised between 8° C. and 15° C.

Alternatively, it is possible to carry out a step of applying a coating layer, for example a coating wax.

Cheese-Based Food Product—Final Product

The cheese-based food product thus obtained, at the end of the step of texturing I (see the final step J), can be consumed immediately.

This food product comprises:
a texture resulting from the physical-chemical transformation of the texture matrix, and
aromas (or more generally flavours), coming from the aromatisation matrix.

This textured cheese-based food product can be packaged, then refrigerated.

In this cheese-based food product, the flavouring microorganisms are:
alive, or
destroyed if necessary, in particular for certain applications (distribution major export, non-cold consumption).

In order to preserve the living microorganisms, those skilled in the art are able to adjust the different steps of the method for manufacturing in such a way as to prevent conditions that can destroy the microorganisms.

Inversely, the destruction of the microorganisms can be obtained through an adapted sterilisation technology, for example by the application of a time/temperature scale of which the range is comprised between 70° C. and 120° C. for 1 to 10 minutes.

### EXAMPLES

### Example 1: Carrying Out of Texture and Aromatisation Matrices, Drying after Mixing of the Two Matrices, then Rehydrating and Texturing the Latter in Order to Obtain a Hard Cheese with 50% Total Dry Matter

Milk of a large mixture (Entremont SODIAAL—Plant of Montauban-de-Bretagne, 35 360) is collected, heat treated at 90° C./2 minutes (ACTINI tubular exchanger type 1959-3 Zone d'Activités de Montigny, 74500 Maxilly-sur-Léman), skimmed (WESTFALIA MSE 25 centrifuge separator, 18 Avenue de (′Europe 02400 CHATEAU THIERRY) to obtain a fat/protein ratio of 1.2.

This raw material is concentrated by Ultra Filtration to a Concentration Factor (CF) of 5 on a TIA/PAII ultrafiltration pilot (TIA—BP 12—Rond Point des Portes de Provence—84501 Bollène Cedex) equipped with mineral membranes made from aluminium/zirconia SCT Membralox type P1960 (cut-off threshold 20 nm).

This retentate is then heat treated at 60° C./20 seconds on the same ACTINI tubular exchanger.

This texture matrix is optionally cooled, before being mixed with at least one aromatic matrix.

At the same time, four high aroma-producing microorganisms were cultivated on suitable mediums in order to produce different aromas:
Hafnia alvei in skimmed milk with 5 g·kg⁻¹ (m/m) of methionine and 10 g·kg⁻¹ (m/m) of BHIYE glucose, at 30° C. and in aerobiosis for 48 hours;
Yarrowia lipolytica on UHT cream (at 30% fat), with 10 g·kg⁻¹ (m/m) of glucose/BHI-YE, at 22° C. under stirring 200 rpm for 48 h;
Propionibacterium freudenreichii on renneted cheese-making whey, heat treated, for 48 h;
Lactococcus lactis ssp lactis, ssp cremoris and var diacetylactis on skimmed milk enriched with 16% Dry Matter with skimmed milk powder, for 24 h.

The four aromatic matrices are mixed for each one at 3% (m/m) with the texture matrix (88% m/m) then the assembly is homogenised at 150 bar on the first stage and 30 bar on the second stage (Rannie 2-head SPX homogeniser—290 Rue Jacquard, 27000 Evreux).

The mixture is then dried on a GEA-MINOR tower (evaporating capacity of 3 I/h) with as parameters:
tower inlet temperature: 220° C. and
tower outlet temperature: 90° C.,
flow rate of 3 I·h⁻¹.

This cheese powder, in the form of a mixture of matrices, is stored at room temperature several weeks in optimum storage conditions (in a vacuum, in a controlled atmosphere that does not result in the caking of the powders).

The characteristics of this cheese powder are mentioned in table 1 hereinbelow:

TABLE 1

| TDM | a_{w} | FATₜₒₜ | FAT_{free} | NT | NCN | NPN | Tg | Solubility | Dispersibility | Wettability |
|---|---|---|---|---|---|---|---|---|---|---|
| (%) | (%) | (%) | (%) | (%) | (%) | (%) | (° C.) | (%) | (%) | (s) |
| 97.7 | 0.14 | 46 | 25 | 36 | 3.6 | 0.1 | 38 | 100 | 69 | >120 s |

with
TDM: total dry matter
a_{w:} water activity
FATₜₒₜ: total fat
FAT_{free}: free fat
NT: total nitrogen
NON: noncasein nitrogen
NPN: nonprotein nitrogen
Tg: glass transition temperature

The determination of total moisture, or of the total dry matter, is obtained in accordance with the document “Les poudres laitières and alimentaires, Techniques d′analyse”, Pierre Schuck et al., Editions Lavoisier, ISBN 978-2-7430-1419-3. This method was also published by Schuck and Dolivet, Le lait, 8: 413-421 (2002).

In substance, this parameter is measured by evaporation of the total water of a test portion in the presence of sand and in a vacuum, after a period of 7 hours in an oven at a temperature of 102+/−2° C.

The determination of the water activity is also obtained in accordance with the document “Les poudres laitières and alimentaires, Techniques d′analyse”, Pierre Schuck et al., Editions Lavoisier, ISBN 978-2-7430-1419-3.

The methods for determining the a_{w} of food products consist of putting the product in balance with the atmosphere of a micro-enclosure, then in measuring the manometric or hygrometric characteristics of the air in balance with the product.

The method for measuring is here based on a mirror hygrometer (method for measuring the dew point).

The sample is introduced into a hermetic measuring chamber containing a mirror of which the temperature can be varied (using a Peltier effect thermoelectric module). The mirror is cooled until condensation appears on the surface thereof. This technique of measuring the a_{w} is based on the fact that air can be cooled until the saturation point without modification of the water content.

In balance, the relative humidity of the air (H_{RE}) present in the chambre is equal to the water activity of the sample. The exact temperature is determined (dew point temperature of dew point) at which the condensation of the water vapour occurs. The surface temperature of the sample is also noted. From these 2 temperatures, the a_{w} is determined.

This measurement here was taken using a resistive, capacitive or mirror a_{w}-meter: Brand GBX—Model FA-st lab—Serial no.: FL 3910111.

The measurement temperature used is 25° C.

This powder is then mixed with a Calcium sequestrant (Na Citrate: 22 g·kg⁻¹ (m/m) of powder), an acidity corrector (citric acid: 8 g·kg⁻¹ (m/m) of powder) and NaCl (10 g·kg⁻¹ (m/m) of powder).

This mixture is first rehydrated in water heated to 50° C. under stirring: 50% water and 50% powder (m/m), then packaged in an adapted 500 g container for example, then maintained at this temperature of 50° C. for 2 hours.

The product is then cooled to 4° C., consumed immediately or stored.

### Example 2: Carrying Out of a Texture Matrix, Drying, Rehydrating and Texturing of the Latter in Order to Obtain a Soft Cheese with 40% Total Dry Matter

Milk of a large mixture (Entremont SODIAAL—Plant of Montauban-de-Bretagne, 35 360) is collected, heat treated at 90° C./2 minutes (ACTINI tubular exchanger type 1959-3 Zone d′Activités de Montigny, 74500 Maxilly-sur-Léman), skimmed (WESTFALIA MSE 25 centrifuge separator, 18 Avenue de (′Europe 02400 CHATEAU THIERRY) then the fat/protein ratio is established at 1.2.

This raw material is concentrated by Ultra Filtration to a Volume Reduction Factor of 5 on a TIA/PAII ultrafiltration pilot (TIA—BP 12—Rond Point des Portes de Provence—84501 Bollène Cedex) equipped with mineral membranes made of aluminium/zirconia SCT Membralox type P1960 (cut-off threshold 20 nm).

This retentate is then heat treated at 60° C./20 seconds on the same ACTINI tubular exchanger.

This texture matrix is optionally cooled before being mixed with at least one aromatic matrix. At the same time, four high aroma-producing microorganisms were cultivated on suitable mediums in order to produce different aromas:
Hafnia alvei in skimmed milk with 5 g·kg⁻¹ (m/m) of methionine and 10 g·kg⁻¹ (m/m) of glucose BHIYE, at 30° C. and in aerobiosis for 48 hours;
Yarrowia lipolytica on UHT cream (at 30%), with 10 g·kg⁻¹ (m/m) of glucose/BHI-YE, at 22° C. under stirring at 200 rpm for 48 h;
Propionibacterium freudenreichii on cheese-making whey, heat treated, for 48 h;
Lactococcus lactis ssp lactis, ssp cremoris and var diacetylactis on skimmed milk enriched with 16% Dry Matter with skimmed milk powder, for 24 h.

The four aromatic matrices are mixed for each one at 5% (m/m) with the texture matrix (80% m/m) then the whole is homogenised at 150 bar on the first stage and 30 bar on the second stage (Rannie 2-head SPX Homogeniser—290Rue Jacquard, 27000 Évreux).

The mixture is then dried on a GEA-MINOR tower (evaporating capacity of 3 I·h⁻¹) with as parameters:
tower inlet temperature: 220° C.,
tower outlet temperature: 80° C., and
mixture flow rate of 3 kg·h⁻¹.

The powder obtained is stored at room temperature several weeks.

The characteristics of this cheese powder are mentioned in table 2 hereinbelow:

TABLE 2

| TDM | a_{w} | FATₜₒₜ | FAT_{free} | TN | NCN | NPN | Tg | Solubility | Dispersibility | Wettability |
|---|---|---|---|---|---|---|---|---|---|---|
| (%) | (%) | (%) | (%) | (%) | (%) | (%) | (° C.) | (%) | (%) | (s) |
| 97.7 | 0.14 | 46 | 25 | 36 | 3.6 | 0.1 | 38 | 100 | 69 | >120 s |

These values were obtained in accordance with the technique disclosed in example 1 hereinabove.

This powder (400 g·kg⁻¹ (m/m) of cheese) is then mixed with a Calcium sequestrant (Na Citrate: 17.6 g·kg⁻¹ (m/m) of powder), a acidity corrector (citric acid: 8 g·kg⁻¹ (m/m) of powder) and NaCl (10 g·kg⁻¹ (m/m) of powder).

This mixture is first rehydrated in water heated to 60° C. in a Thermomix under stirring (variation 1.5 for 1 minute, variation 2.5 for 2 minutes to mix the powder well and variation 2 for 2 minutes), then packaged in an adapted 500 g container for example and maintained at a temperature of 50° C. for 2 hours.

The product is then cooled to 4° C., stored and consumed.

1. Method for manufacturing a cheese powder,
said cheese powder being suitable for being rehydrated and textured for the manufacturing of a cheese-based food product,
said method for manufacturing comprising:
a) a step of providing (A):
at least one aromatic matrix resulting from a step of culturing at least one flavouring microorganism in a culture medium, said at least one aromatic matrix being intended for carrying out the flavouring of said cheese-based food product, and
at least one texture matrix, that is intended for carrying out the texture of said cheese-based food product,
said at least one texture matrix comprises proteins of which at least some of said proteins consist of coagulating proteins that are able to coagulate to form a gel, which coagulating proteins have not been subjected to prior coagulation,
b) a step of mixing (B) said at least one aromatic matrix and said at least one texture matrix, in order to obtain a mixture of matrices, and
c) a step of drying (C) at least one of said matrices or said mixture of matrices to obtain a powder consistency, when at least one of said matrices or said mixture of matrices has a consistency ranging from liquid to paste,
said steps are implemented to obtain a cheese powder that has the following characteristics:
a total dry extract greater than or equal to 95% m/m,
a water activity a_{w} having a value of 0.1 to 0.25, even of 0.1 to 0.2, and
said coagulating proteins derived from the at least one texture matrix have not been subjected to prior coagulation.

2. Method for manufacturing a cheese powder, according to claim 1, wherein said method for manufacturing is implemented:
without said step of mixing (B), to obtain a cheese powder consisting of a combination of matrices comprising said at least one aromatic matrix and said at least one texture matrix, separated with respect to one another and each one in the form of powder, or
with said step of mixing (B), to obtain said cheese powder in the form of a mixture of matrices in the form of powder.

3. Method for manufacturing a cheese powder, according to claim 1, wherein said step of providing (A) consists of providing matrices that have, independently of one another, a consistency selected from:
a consistency of powder, or
a consistency ranging from liquid to paste.

4. Method for manufacturing a cheese powder, according to claim 1, wherein said steps (A, B, C) are selected from one of the following combinations of steps:
according to a first combination (i):
said step of providing (A) comprises the providing of said matrices each having the consistency of a powder, and
said step of mixing (B) consists of mixing said powder matrices to obtain said mixture of matrices in the form of powder,
or
according to a second combination (ii):
said step of providing (A) comprises the providing of at least one matrix having a consistency ranging from liquid to paste, then
said step of drying (C) consists of drying said at least one matrix to obtain matrices each having the consistency of a powder, then
said step of mixing (B) consists of mixing said powder matrices to obtain said mixture of matrices in the form of powder,
or
according to a third combination (iii):
said step of providing (A) consists of providing at least one matrix having a consistency ranging from liquid to paste, then
said step of mixing (B) consists in mixing said matrices to obtain a mixture of matrices having a consistency ranging from liquid to paste, then
said step of drying (C) consists of drying said mixture of matrices to obtain said mixture of matrices in the form of powder,
or
according to a fourth combination (iv):
said step of providing (A) consists of providing at least one matrix having a consistency ranging from liquid to paste, then
said steps of mixing and of drying (B, C) said matrices are implemented simultaneously (co-drying), to obtain said mixture of matrices in the form of powder.

5. Method for manufacturing a cheese powder, according to claim 1, wherein:
in the case of matrices having a consistency ranging from liquid to paste, said step of mixing (B) comprises a step of homogenisation, and/or
in the case of a mixture of matrices having a consistency ranging from liquid to paste, said step of drying (C) said mixture of matrices consists of a step of atomisation.

6. Method for manufacturing a cheese powder, according to claim 1, wherein the texture matrix consists of a retentate resulting from a filtration technique of a dairy product and/or of a plant juice.

7. Method for manufacturing a cheese powder, according to claim 1, wherein said at least one flavouring microorganism is alive in said cheese powder.

8. Cheese powder
selected from:
a combination of matrices comprising said at least one aromatic matrix and said at least one texture matrix, separated with respect to one another, each one in the form of powder, or
said mixture of matrices, in the form of a powder,
wherein said cheese powder has the following characteristics:
a total dry extract greater than or equal to 95% m/m,
a water activity a_{w} having a value of 0.1 to 0.25,
said coagulating proteins derived from the at least one texture matrix have not been subjected to prior coagulation.

9. Method for the manufacturing of a cheese-based food product, said method comprising the following steps in succession:
a step of providing (E) a cheese powder according to claim 8,
a step of mixing (F) matrices of the combination of matrices in the form of powder,
a step of rehydrating (G) the powder texture matrix or the mixture of powder matrices, in the presence of at least one Ca-sequestering salt, to ensure the rehydration/solubilisation of said coagulating proteins and to obtain a cheese matrix that has a consistency ranging from liquid to paste,
where applicable, a step of mixing (H) texture and aromatisation matrices,
a step of texturing (I), during which said cheese matrix is subjected to physical-chemical conditions of texturing, always in the presence of at least one Ca-sequestering salt, for the coagulation of said coagulating proteins and to form the gel, said physical-chemical texturing conditions are adapted according to the final texture sought for said cheese-based food product.

10. Method for the manufacturing of a cheese-based food product, according to claim 9, wherein said step of rehydrating is carried out in the following conditions:
a rehydration rate ranging from 40% H₂O to 80% H₂O,
a temperature ranging from 30° C. to 80° C.,
a rehydration time of 1 to 10 h,
a dose of Ca-sequestering salt ranging from 2 to 50 g·kg⁻¹ of powder (m/m), and
a dose of acidity-regulating salt ranging from 0 to 50 g·kg⁻¹ of powder (m/m).

11. Method for the manufacturing of a cheese-based food product, according to claim 9, wherein, during the step of texturing, the physical-chemical texturing conditions are selected from the temperature, the pH, the dose of NaCl, the dose of Ca-sequestering salt and the dose of acidity-regulating salt.

12. Method for the manufacturing of a cheese-based food product, according to claim 11, wherein the step of texturing is adjusted with the following physical-chemical texturing conditions:
a pH comprised between 4.5 and 6.5,
a temperature comprised between 10° C. and 60° C. for 1 to 10 h,
a concentration in NaCl comprised between 0.1 and 2% m/m.

13. Cheese-based food product, resulting from a method for manufacturing according to claim 9.

14. Method for the manufacturing of a cheese-based food product, said method is comprising the following steps in succession:
a step of providing (E) a cheese powder resulting from a method for manufacturing according to claim 1,
a step of mixing (F) matrices of the combination of matrices in the form of powder,
a step of rehydrating (G) the powder texture matrix or the mixture of powder matrices, in the presence of at least one Ca-sequestering salt, to ensure the rehydration/solubilisation of said coagulating proteins and to obtain a cheese matrix that has a consistency ranging from liquid to paste,
where applicable, a step of mixing (H) texture and aromatisation matrices,
a step of texturing (I), during which said cheese matrix is subjected to physical-chemical conditions of texturing, always in the presence of at least one Ca-sequestering salt, for the coagulation of said coagulating proteins and to form the gel, said physical-chemical texturing conditions are adapted according to the final texture sought for said cheese-based food product.

15. The method of claim 1, wherein in step a) said at least one texture matrix comprises proteins and fat.

16. The method of claim 3, wherein said at least one texture matrix has a consistency ranging from liquid to paste, comprising from 6% to 25% m/m of proteins and from 0% to 30% m/m of fat.

17. The method of claim 9, wherein the step of rehydrating (G) the powder texture matrix or the mixture of powder matrices is performed in the presence of both the at the least one Ca-sequestering salt and also at least one acidity-regulating salt, and
wherein the step of texturing (I) is performed in the presence of both the at least one Ca-sequestering salt and also an acidity-regulating salt.

18. The method of claim 12, wherein the step of texturing is adjusted with the following additional physical-chemical texturing conditions:
a dose of Ca-sequestering salt from 2 to 50 g·kg⁻¹ of powder (m/m), and
a dose of acidity-regulating salt from 0 to 50 g·kg⁻¹ of powder (m/m).

19. The method of claim 14, wherein the step of rehydrating (G) is performed in the presence of both the at least one Ca-sequestering salt and also least one acidity-regulating salt, and
wherein the step of texturing (I) is performed both in the presence of both the at the least one Ca-sequestering salt and also an acidity-regulating salt.

20. The method of claim 10, wherein said step of rehydrating is carried out at a temperature ranging from 30° C. to less than 60° C.
